(19) United States
(12) Patent Application Publication
(10) Pub. No.: US 2022/0268368 A1
(43) Pub. Date: Aug. 25, 2022

(54) DISCHARGE CONNECTION FOR THE SEPARATED DISCHARGE OF FLUIDS OF DIFFERENT DENSITIES

(71) Applicant: NORMA Germany GmbH, Maintal (DE)

(72) Inventors: René Schindler, Maintal (DE); Sascha Frickel, Maintal (DE); Sven Schwäblein, Maintal (DE); Dirk Hagenkord, Maintal (DE)

(21) Appl. No.: 17/627,760

(22) PCT Filed: Jul. 13, 2020
(86) PCT No.: PCT/EP2020/069700

§ 371 Date: Jan. 17, 2022

(30) Foreign Application Priority Data
Jul. 16, 2019 (DE) 10 2019 119 302.8

(51) Int. Cl. F16K 27/02; B60K 15/035

(52) U.S. Cl. CPC F16K 27/0209; B60K 15/03519; B60K 2015/03473

(57) ABSTRACT

A discharge connection, an inlet pipe, an outlet pipe and a drain channel are provided. On an outer end, the outlet pipe has an outwardly closing check valve with a valve body and a valve seat. The outlet pipe has a first coupling geometry at the outer end, which can be interlockingly connected to a conduit coupling. The check valve is designed to be moved from the valve seat into a open position, spaced apart from same, by a profile element projecting into the outer end.

### INTRODUCTION

The disclosure relates to a discharge connection for the separated discharge of fluids of different densities, such as in particular water and fuel.

Such a discharge connection is used, for example, in connection with fuel tanks in order to drain water, which has collected on the base of the tank, via a drain channel by opening a valve element which is optionally configured as a screw. At the same time, therefore, the discharge connection provides an outlet for the fuel which is continuously taken during operation. For servicing operations, however, it may also be necessary to close the outlet for the fuel. To this end, it has been proposed in the prior art to connect a valve unit to the outlet of the discharge connection, an outlet pipe, which has a connecting pipe geometry for connecting further conduits, being connected to said valve unit.

Such discharge connections are thus made up of a relatively large number of individual parts, wherein at least the valve unit is generally manufactured from metal in order to be sufficiently resistant. Thus the discharge connections which are known from the prior art are firstly relatively heavy, but are secondly only able to be produced in an elaborate manner and thus cost-intensively. In this case, the risk of leakages is present due to the required connecting points.

### SUMMARY

An object of the disclosure, per an embodiment, therefore, is to avoid the drawbacks of the prior art and to specify a discharge connection which may be produced cost-effectively, in particular with a low degree of effort, and which has a low weight. Incorrect operation is also intended to be made as difficult as possible.

In a discharge connection having a cup-shaped housing which comprises a housing base and a housing wall, wherein a connecting geometry is configured externally on the housing wall for inserting into a container opening, wherein an inlet pipe is guided from an inlet side to an outlet side through the housing base, and a collecting chamber is configured between the inlet pipe and the housing wall, wherein the housing has a drain channel which leads from the collecting chamber to the outlet side and is closable from the outlet side, it is provided that the inlet pipe on the outlet side transitions into an outlet pipe which on an outer end has an outwardly closing check valve with a valve body and a valve seat arranged on the outlet side, that the outlet pipe has a first coupling geometry at the outer end thereof which can be interlockingly connected to a conduit coupling, and wherein the check valve is designed to be moved from the valve seat into an open position spaced apart from same, by a profile element projecting into the outer end.

As a result, per an embodiment, the discharge of liquid through the outlet pipe via the inlet pipe may be only possible when the check valve is open. This may be achieved by pushing the valve body in toward the inlet pipe. By way of example, a profile element is inserted into the outlet pipe, said profile element being brought into abutment with the valve body and being lifted away from the valve seat by moving in the direction of the inlet pipe. As a result, by way of example an annular through-flow cross section is opened between the valve body and the valve seat, the liquid flowing therethrough. As result, a liquid may be discharged from the container through the outlet pipe when a discharge connection is screwed into a container opening.

In this case, only a liquid having a lower density, such as for example fuel, is discharged through the outlet pipe. The discharge connection, however, may permit a liquid having a greater density, such as for example water, to drain via the separately designed and closable drain channel. As a result, the discharge connection provides a combination for the separate discharge of two liquids of different densities, such as water and fuel. Due to the simple construction, the discharge connection may be produced in one piece from a plastics material, except for the valve body and possibly provided seals. The manufacture is highly simplified relative to the prior art and the use of plastics material promotes a reduction in weight. Moreover, the discharge connection thus produced does not tend to oxidize and therefore is particularly suitable for installation in a motor vehicle, namely a passenger motor vehicle, a truck, an agricultural vehicle, or the like. Additionally, the connections between the individual components of the discharge connection may be saved, which improves the tightness of the discharge connection.

The closable drain channel may be closed by a closure element, for example a blind plug. To this end, the drain channel and the closure element may be shaped in a complementary manner to one another, such that the closure element may be removed and inserted in a simple manner. The closure element is preferably produced, per an embodiment, from a material which is adapted to the material of the discharge connection. In particular, it may also be advantageous to produce this closure element from a plastics material, due to the positive properties regarding weight and manufacturing costs. However, this plastics material could also differ in terms of its properties from those of the discharge connection. The closure element could also be produced in one piece.

The inlet pipe preferably, per an embodiment, extends on the inlet side with its main axis of extension significantly over the connecting geometry. As a result, the inlet pipe is able to receive only the liquid having the lower density, whilst the liquid having the greater density may be drained exclusively via the drain channel below an inlet opening of the inlet pipe, said drain channel opening into the housing base. As a result, water is able to be reliably prevented from reaching the engine supplied with fuel, when the discharge connection is used in a fuel tank.

In an embodiment, a separate conduit coupling with a second coupling geometry which is configured in a complementary manner to the first coupling geometry is also provided, wherein the profile element is arranged on the conduit coupling and projects at least into the region of the second coupling geometry. The opening and closing of the outlet pipe may be carried out by simple attachment or removal of the conduit coupling at the outer end of the outlet pipe. If the conduit coupling is attached with its second coupling geometry to the first coupling geometry, the profile element projects into the outlet pipe and pushes the valve body from its valve seat further into the interior of the outlet pipe. Thus the outlet pipe is opened and the liquid is able to flow out. By removing the conduit coupling, the check valve thus closes again due to gravity and the liquid is no longer able to leave the outlet pipe.

Preferably, per an embodiment, the conduit coupling has a first axial end with the second coupling geometry and a second axial end, wherein at least one through-flow holder is arranged between the two axial ends and the profile element extends from the at least one holder in the direction of the first axial end. As a result, the profile element could preferably, per an embodiment, be held in the interior of the through-flow cross section. Particularly preferably, per an embodiment, this profile element is thus held centrally in the through-flow cross section such that by means of the profile element a force acts centrally on the valve body. As a result, the valve body may be prevented from being tilted. So as not to interrupt the through-flow from the outlet pipe, the holder is designed to be able to be flowed-through and as a result has one or more cutouts or openings. The holder could be designed, for example, in the manner of a grille or a sieve.

In an embodiment, the through-flow holder has at least one arm extending in the radial direction, the profile element being fastened thereto. The at least one arm could be configured as a plurality of arms which jointly hold the profile element. As a result, the holding of said profile element is robust and reliable so that in the installed state of the conduit coupling the check valve always remains open. It may be advantageous per an embodiment if, when a plurality of arms are used, these arms are distributed symmetrically over the through-flow cross section.

The profile element could have a pin extending in the axial direction on the conduit coupling or could be configured as such. As a result, the profile element has a slim design which is able to extend in the axial direction and a through-flow cross section of the conduit coupling is virtually unimpaired. Additionally, the alignment of the profile element with a corresponding shape feature of the valve body is relatively simple.

Moreover, on an outwardly oriented side the valve body could have a recess which is configured in a complementary manner to the profile element. The recess permits a precise matching of the mobility of the valve body by the profile element, when both components are adapted to one another. Achieving an intended degree of opening of the check valve in a reliable manner is thus not dependent on an outer surface of the valve body but merely on the recess. The manufacture of the valve body could thus be simplified.

It may be advantageous, per an embodiment, if the conduit coupling is configured as a plug connector with an integrated holding clip. The removal and plugging-on of the conduit coupling is significantly simplified thereby relative to screw connectors, since for the attachment the conduit coupling only has to be plugged on and secured by moving the holding clip. The removal of the conduit coupling is accordingly carried out by moving the holding clip and pulling-off of the conduit coupling in opposing directions. In combination with the use of the check valve, a particularly simple handling may be achieved for removing liquids having a greater density from the drain channel.

Preferably, per an embodiment, the inlet pipe and the outlet pipe are arranged concentrically to one another. The discharge connection thus has a simplified and more compact design and the flow from the inlet pipe to the outlet pipe is not impaired by shoulders, curvatures or other deflections.

The drain channel could, per an embodiment, advantageously be located radially outside the inlet pipe and the outlet pipe. The ability to reach and handle the drain channel, in order to open and close the drain channel, may be improved thereby.

### BRIEF DESCRIPTION OF THE FIGURES

Further features, details and advantages of the disclosure emerge from the wording of the claims and from the following description of exemplary embodiments, with reference to the drawings, in which:

FIG. 1 shows a sectional view of the discharge connection.

FIG. 2 shows a three-dimensional view of the conduit coupling.

FIG. 3 shows a side view of the conduit coupling.

FIG. 4 shows a side view of the discharge connection.

### DETAILED DESCRIPTION

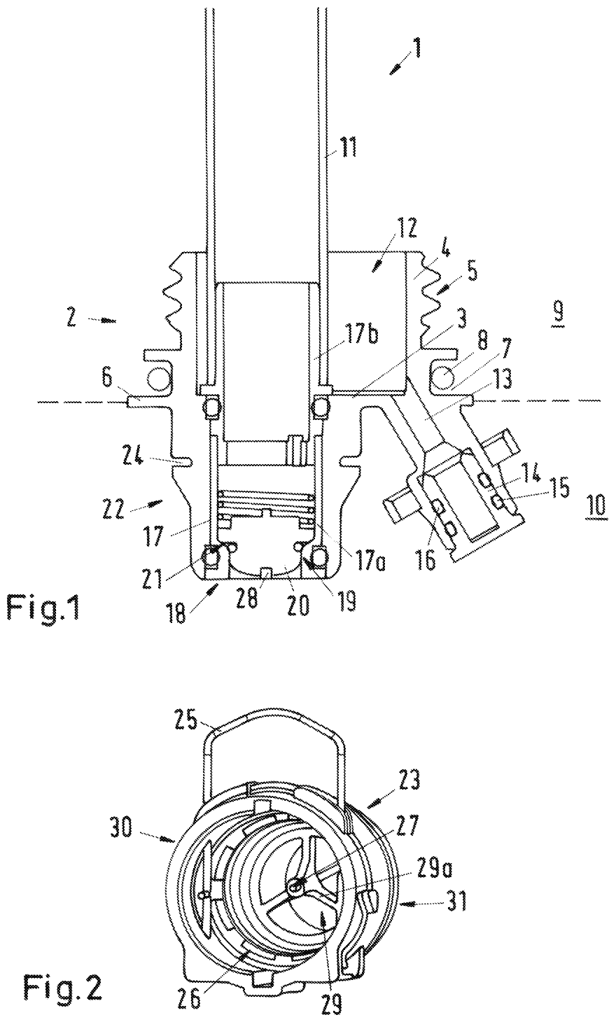

FIG. 1 shows a sectional view of a discharge connection 1 which may be inserted into a container opening (not shown) in order to allow fluids of different densities to drain separately from one another. The discharge connection 1 has a cup-shaped housing 2 with a housing base 3 and a housing wall 4. A connecting geometry 5 in the form of an external thread is attached to an outer face of the housing wall 4. As a result, the discharge connection 1 may be screwed in a fluid-tight manner into a correspondingly shaped container opening as far as a radially outwardly projecting stop 6. In the region of the stop 6 is a peripheral groove 7 in which a sealing ring 8 is arranged in order to produce a sealing action in the container opening.

The housing base 3 may define a parting plane for dividing the sides of the discharge connection 1 into an inlet side 9 and an outlet side 10. In this case, the inlet side 9 is arranged inside the corresponding container, whilst the outlet side 10 is accessible to a user.

The discharge connection 1 has by way of example a rectilinear hollow-cylindrically shaped inlet pipe 11 which extends from a region close to the housing base 3 far above the housing 2 in the direction of the inlet side 9. A collecting chamber 12 is formed inside the housing 2, between the inlet pipe 11 and the housing wall 4, a liquid having a greater density collecting in said collecting chamber and flowing into a drain channel 13 which radially outwardly adjoins the housing base 3 in an oblique manner. As result, water which collects, for example, in a fuel tank is able to be drained through the drain channel 13. The simultaneous discharge of fuel may be prevented thereby. The drain channel 13 is closed by a blind plug 14, for example. This blind plug is provided by way of example with sealing rings 15 and 16 in order to ensure a permanently fluid-tight closure.

During conventional operation of the discharge connection 1, for example for providing fuel from a fuel tank, an outlet pipe 17 is provided. The outlet pipe 17 is arranged concentrically to the inlet pipe 13, for example. At an outer end 18 said outlet pipe has a check valve 19 which has a valve body 20 and a correspondingly shaped, for example annular, valve seat 21. In the view shown, the valve body 20 is located on the valve seat 21 and thereby closes the outlet pipe 17. The valve body 20 may be pushed onto the valve seat 21 by the static pressure resulting from the filling volume of the fuel tank. By pressing the valve body 20 in the opposing direction into the outlet pipe 17 and oriented away from the valve seat 21, the valve seat 21 is released and fuel may flow out of the inlet pipe 11 through the outlet pipe 17.

The outlet pipe 17 has a first coupling geometry 22 which is able to be interlockingly connected to a conduit coupling 23 shown in FIG. 2. The first coupling geometry 22 could have by way of example a peripheral groove 24 into which a holding clip 25 may be inserted in order to secure the conduit coupling 23 correspondingly to the outlet pipe 17. It goes without saying that the conduit coupling 23 has a second coupling geometry 26 which is configured in a complementary manner to the first coupling geometry 22.

The conduit coupling 23 also has a profile element 27 which is configured in a complementary manner to an outwardly oriented recess 28 of the valve body 20. By placing the conduit coupling 23 onto the outlet pipe 17 the profile element 27 projects into the recess 28, comes into abutment with a shape feature of the recess 28 or a surrounding region of the valve body 20, and subsequently pushes the valve body 20 further into the outlet pipe 17. As a result, by the complete attachment of the conduit coupling 23 onto the outlet pipe 17, the check valve 19 is opened immediately.

The profile element 27 in the exemplary view is designed at least in some sections as a pin which is arranged on a through-flow holder 29. This holder has by way of example three arms 29a which extend in the radial direction and which are fastened in the interior of the conduit coupling 23. The arms 29a are slim and configured to be approximately rod-shaped, so that a sufficient open through-flow cross section remains. By way of example, the profile element 27 is arranged centrally in the conduit coupling 23 and the recess 28 is positioned centrally on the valve body 20. The conduit coupling 23 has a first axial end 30, the second coupling geometry 26 being configured thereon. A second axial end 31 opposes the first end 30. The profile element 27 is located between the two axial ends 30 and 31 and in this case extends in the axial direction.

All of the parts shown may be manufactured from a plastics material. In this case the discharge connection 1 could be designed substantially in one piece, wherein for accommodating the check valve 19 the outlet pipe 17 may also have two pipe pieces 17a and 17b which may be produced separately from one another and which may be dismantled from one another for inserting and subsequently enclosing the valve body 20. The holding clip 25 of the conduit coupling 23 could also be produced from a metal material in order to ensure a high level of strength, even when handled roughly.

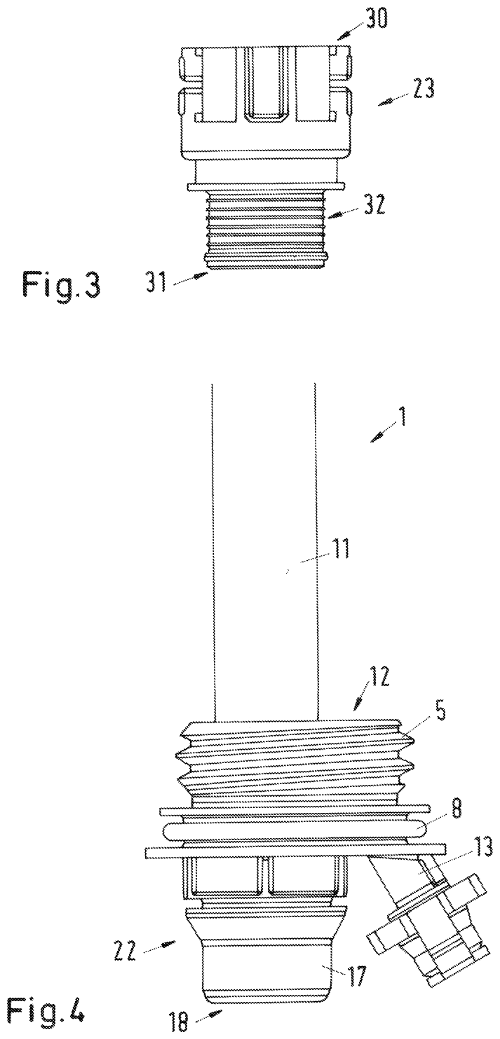

For the sake of completeness, the components shown in FIGS. 1 and 2 are shown in different views in FIGS. 3 and 4. FIG. 3 shows the conduit coupling 23 with the first axial end 30 located at the top in the drawing plane and the second axial end 31 located therebelow. The second axial end could provide a ribbed lateral surface 32 for connection to a hose line, or the like.

FIG. 4 shows an external view of the discharge connection 1 without the conduit coupling 23 attached thereto.

The invention is not limited to one of the above-described embodiments but may be modified in many different ways.

All of the features and advantages including structural details, three-dimensional arrangements and method steps emerging from the claims, the description and the drawing, may be essential to the invention both individually and in very different combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

1 Discharge connection
2 Housing
3 Housing base
4 Housing wall
5 Connecting geometry
6 Stop
7 Groove
8 Sealing ring
9 Inlet side
10 Outlet side
11 Inlet pipe
12 Collecting chamber
13 Drain channel
14 Closure
15 Sealing ring
16 Sealing ring
17 Outlet pipe
17a Pipe piece
17b Pipe piece
18 Outer end
19 Check valve
20 Valve body
21 Valve seat
22 First coupling geometry
23 Conduit coupling
24 Groove
25 Holding clip
26 Second coupling geometry
27 Profile element
28 Recess
29 Holder
29a Arm
30 First axial end
31 Second axial end
32 Lateral surface

1. A discharge connection having a cup-shaped housing which comprises a housing base and a housing wall, wherein a connecting geometry is configured externally on the housing wall for inserting into a container opening, wherein an inlet pipe is guided from an inlet side to an outlet side through the housing base, and a collecting chamber is configured between the inlet pipe and the housing wall, wherein the housing has a drain channel which leads from the collecting chamber to the outlet side and is closable from the outlet side, wherein the inlet pipe on the outlet side transitions into an outlet pipe which on an outer end has an outwardly closing check valve with a valve body and a valve seat arranged on the outlet side, in that the outlet pipe has a first coupling geometry at the outer end thereof, which can be interlockingly connected to a conduit coupling, and wherein the check valve is designed to be moved from the valve seat into an open position, spaced apart from same, by a profile element projecting into the outer end.

2. The discharge connection as claimed in claim 1, wherein a separate conduit coupling with a second coupling geometry which is configured in a complementary manner to the first coupling geometry, wherein the profile element is arranged on the conduit coupling and projects at least into the region of the second coupling geometry.

3. The discharge connection as claimed in claim 2, wherein the conduit coupling has a first axial end with the second coupling geometry and a second axial end, wherein at least one through-flow holder is arranged between the two axial ends and the profile element extends from the at least one holder in the direction of the first axial end.

4. The discharge connection as claimed in claim 3, wherein the through-flow holder has at least one arm extending in the radial direction, the profile element being fastened thereto.

5. The discharge connection as claimed in claim 2, wherein the profile element has a pin extending in the axial direction on the conduit coupling or is configured as such.

6. The discharge connection as claimed in claim 1, wherein on an outwardly oriented side the valve body has a recess which is configured in a complementary manner to the profile element.

7. The discharge connection as claimed in claim 2, wherein the conduit coupling is configured as a plug connector with an integrated holding clip.

8. The discharge connection as claimed in claim 1, wherein the inlet pipe and the outlet pipe are arranged concentrically to one another.

9. The discharge connection as claimed in claim 1, wherein the drain channel is located radially outside the inlet pipe and the outlet pipe.
